(19) United States
(12) Patent Application Publication
(10) Pub. No.: US 2006/0121223 A1
(43) Pub. Date: Jun. 8, 2006

(54) Container package

(75) Inventors: Brian J. Chisholm, Toledo, OH (US); Anthony J. Scott, Sylvania, OH (US)

Correspondence Address: VENABLE LLP, P.O. BOX 34385, WASHINGTON, DC, 20045-9998, US

(73) Assignee: GRAHAM PACKAGING COMPANY, L.P., York, PA (US)

(21) Appl. No.: 11/001,191

(22) Filed: Dec. 2, 2004

(51) Int. Cl. B32B 27/08; B29C 49/00

(52) U.S. Cl. 428/35.7; 264/534; 264/536; 425/527

(57) ABSTRACT

A plastic, hollow blow-molded article, from which a container can be formed, includes a container body and an integrally connected base. The base is separated from the container body by severing the article along a cut line. After severing, the container body and the base are telescopically joined together at the open end of the container body to form the container. The base provides a closure for the container. A mold is provided for blow-molding the article from a tubular parison.

This invention relates generally to containers for packaged items of merchandise, such, for example, as wearing apparel or a garment or the like. The invention also relates to hollow blow-molded articles from which the containers can be made, as well as to a method of making the blow-molded articles.

### BACKGROUND AND SUMMARY OF THE INVENTION

Containers are often made from hollow plastic blow-molded articles. Typically the top of the blow-molded article is trimmed away to form a container with an opening. A product such as a garment is placed inside the container through the opening, and then the opening is closed to complete the container package. The trimmed top becomes useless, and is usually scrapped or recycled. This is wasteful and adds to the cost of the container.

In accordance with the present invention, instead of scrapping the trimmed portion, the trimmed portion is used to close the container. The trimmed portion preferably is the base or bottom portion of the container as molded, and is rejoined to the container body either by telescoping it over the outside of the container body at the open end or by inserting it into the open end of the container body. It is expected that a hollow article will be molded and cut into a container body and base by the container manufacturer, the container body and the trimmed base will be shipped to the packager, the packager will insert the product into the open end of the container body, and then the base will be applied to the open end of the container body to form a closed container and complete the container package.

Further in accordance with the invention, the article from which the container is made is blow-molded in a mold, after which the mold is opened at a mold parting line to create a small gap. A knife blade, preferably carried by a protective sheath mounted on the mold, is then projected through the gap to trim the base from the container body. Because the mold is completely closed during blow-molding, the wall of the container will not blow through the knife opening.

One object of this invention is to provide containers, blow-molded articles, and a method of making the articles, having one or more of the foregoing features and capabilities.

### BRIEF DESCRIPTION OF THE DRAWINGS

These and other objects, features, advantages and aspects of the present invention will be apparent from the following detailed description of the preferred embodiments and best mode, appended claims and accompanying drawings, in which:

FIG. 1 is an elevational view of a container, with parts in section, for an item of merchandise such as a garment, constructed in accordance with the invention;

FIG. 2 is a side view of the container showing the container base separated from the container body;

FIG. 3 is an enlarged fragmentary sectional view of a portion of FIG. 1 shown within the area 3;

FIG. 4 is an elevational view of a blow-molded article from which the container of FIG. 1 is made;

FIG. 5 is an enlarged fragmentary sectional view of a portion of FIG. 4 shown within the area 5;

FIG. 6 is a sectional view of a blow-mold for forming a blow-molded article in accordance with the invention;

FIG. 7 is a sectional view taken on the line 7-7 in FIG. 6;

FIG. 8 is a view of a container of modified construction;

FIG. 9 is an enlarged fragmentary sectional view of a portion of FIG. 8 shown within the circle 9;

FIG. 10 is an elevational view of a blow-molded article from which the container of FIGS. 8 and 9 is formed;

FIG. 11 is an enlarged fragmentary sectional view of a portion of FIG. 10 shown within the circle 11;

FIG. 12 is a fragmentary sectional view showing a blow-molded article from which a container of modified construction is formed;

FIG. 13 is a fragmentary sectional view of a container formed from the blow-molded article of FIG. 12;

FIG. 14 is a fragmentary sectional view of the bottom of a blow-molded article of modified construction; and

FIG. 15 is a sectional view of the bottom of a container formed from the blow-molded article of FIG. 14.

### DETAILED DESCRIPTION OF THE PREFERRED EMBODIMENTS

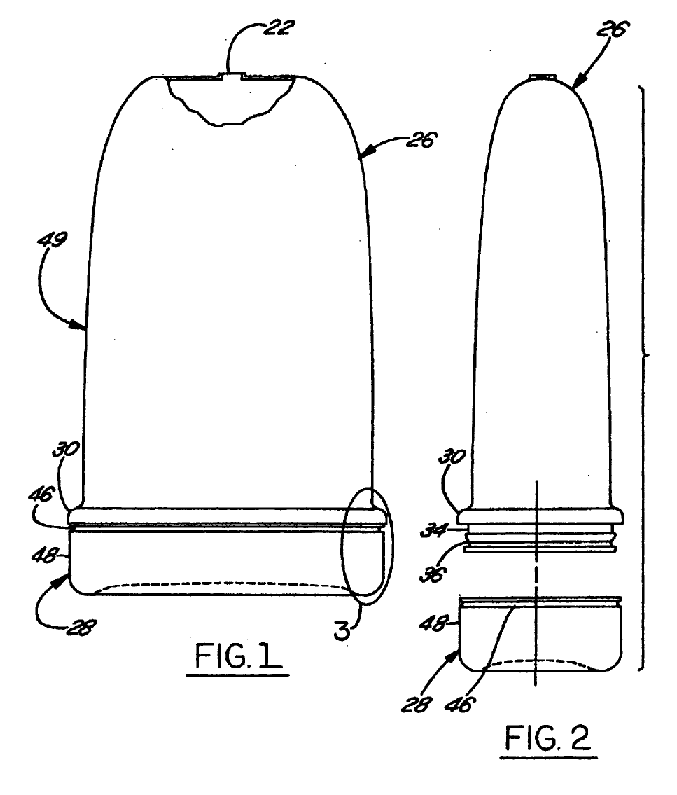

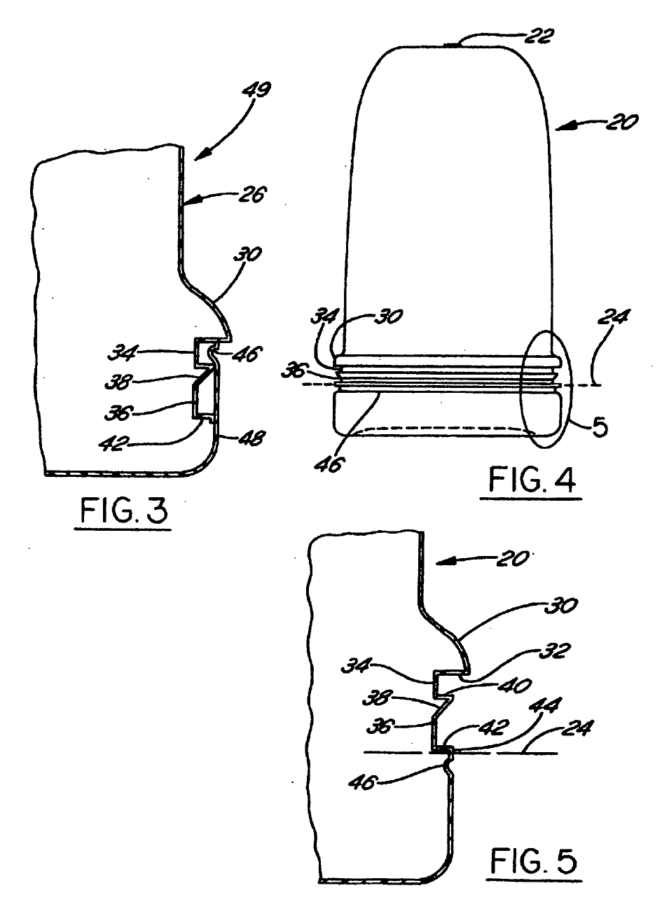

Referring now more particularly to the drawings and especially to FIGS. 1-5, there is shown a hollow blow-molded plastic article 20 (FIGS. 4-5), which is closed except for a small opening 22 left by a blow pin which may be left open or closed in any suitable manner as by a cap. The article 20 is intended to be transversely cut along a cut plane or cut line 24 into two parts, namely a container body 26 and a base 28 (FIGS. 1-3).

Near its lower end but above the cut line 24, the blow-molded article 20 is formed with an annular radially outward bulge 30 having a bottom which forms the horizontal upper wall 32 of an annular radially inwardly extending and outwardly opening channel 34.

Beneath the channel 34, the article 20 has an annular channel 36 which includes an upper wall 38 inclined downwardly and radially inwardly from the outer edge of the horizontal bottom wall 40 of the channel 34, and also includes a horizontal bottom wall 42. An annular connecting wall 44 extends downward from the outer edge of the bottom wall 42 of the channel 36 and crosses or intersects the cut line 24. The wall 44 is vertical except for a radially inwardly extending and outwardly opening annular channel 46 just beneath the cut line 24, and continues downwardly to form an annular side wall 48 of the base 28.

After the blow-molded article 20 is severed along the cut line 24, the separated base 28 is telescoped over the open end of the container body 26. The channel 46, which is close to the cut line and is now part of the base, is expanded over the outer edge of the bottom wall 42 of the channel 36 and engages the inclined wall 38 on the container body 26 as the base 28 continues to telescope over the open end of the container body. The outer surface of the inclined wall 38 serves as a cam surface, expanding the side wall 48 of the base and causing the channel 46 to snap into the channel 34 in the container body. The channels 34 and 46 serve as interengageable locking formations holding the base 28 and container body 26 closed. The upper edge of the base, which is the lower half of wall 44 after the article 20 is cut along the cut line 24, engages the upper wall 32 of the channel 34 to positively locate the base in assembled relation on the container body. The assembled container body 26 and base 28 form a container 49 in which the base serves as a closure for the container.

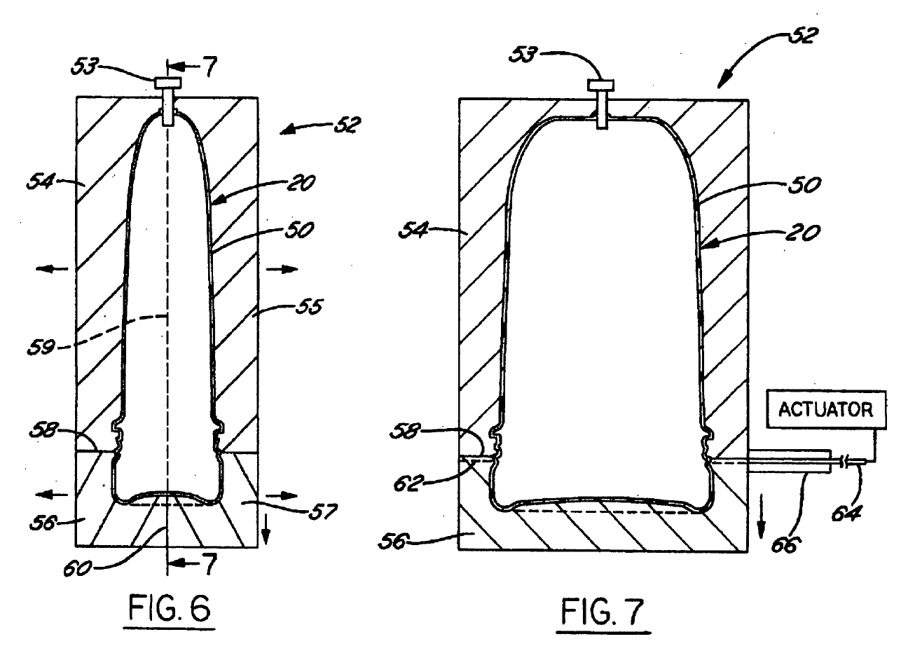

Referring to FIGS. 6 and 7, the hollow plastic article 20 is shown being blow-molded from a tubular parison in a cavity 50 of a four-piece mold 52 by introducing pressure fluid into the mold through a blow pin 53. The mold 52 has two relatively large upper mold halves 54 and 55 and two relatively smaller lower mold halves 56 and 57 which are closed against each other to form the mold cavity. The upper mold halves 54, 55 are separable from the lower mold halves 56, 57 along a parting line 58. The upper mold halves 54, 55 are separable from each other along a parting line 59 and the lower mold halves are separable from each other along a parting line 60. The parting lines 59 and 60 are orthogonal to the parting line 58.

After blow-molding, the two lower mold halves 56 and 57 are moved downwardly at the parting line 58 to create a slight gap 62, shown by a broken line in FIG. 7, between the upper and lower mold halves. The gap 62 establishes a cut plane or cut line at which the article is to be severed. The upper and lower mold halves crack open at parting lines 59 and 60 (less than 0.060″) to relieve the mold clamp pressure prior to the opening of the mold at parting line 58 to allow for cutting the container. A knife blade 64 carried in a protective sheath 66 external to the mold cavity 50 is mounted on one of the upper mold halves. After the upper and lower mold halves have been parted, the knife blade 64 is projected through the gap 62 by an actuator to trim or cut away the bottom portion of the article 20, so that the bottom portion of the article will become the base and the remaining portion will become the container body of the container shown in FIGS. 1-3.

The lower mold halves stay in their down position while the upper mold halves and the lower mold halves are opened to a further opened position along parting lines 59 and 60 to allow the container body and base to be removed.

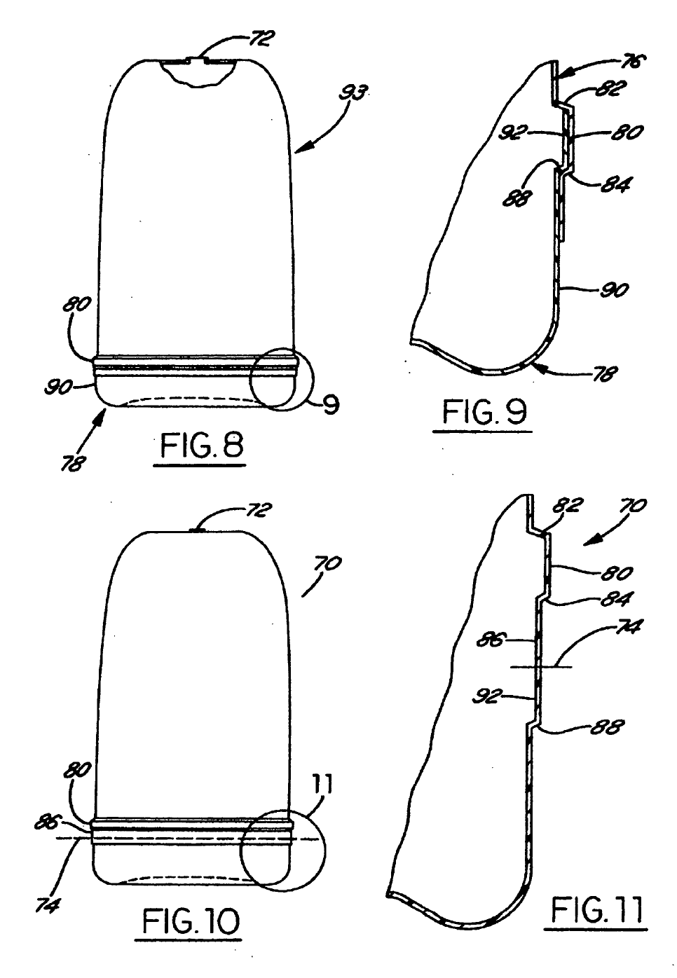

Referring now to FIGS. 8-11, there is shown a hollow blow-molded plastic article 70 which is closed except for a small blow pin opening 72. The article 70 is intended to be transversely cut along a cut plane or cut line 74 into two parts, namely a container body 76 and a base 78.

Near its lower end, but above the cut line 74, the blow-molded article 70 has a radially outwardly extending and inwardly opening annular channel 80 which extends around the article and is provided with a upper wall 82 which slants downwardly and radially outwardly and a bottom wall 84 which slants upwardly and radially outwardly.

Beneath the channel 80, an annular vertical connecting wall 86 extends downward from the inner edge of the bottom wall 84 of the channel 80 and crosses or intersects the cut line 74. Beneath the cut line 74, the wall 86 has a downwardly sloping and radially inwardly extending annular offset 88 from which it continues downwardly and vertically to form the sidewall 90 of the base. The portion of the wall 86 beneath the cut line and including the offset 88 form a generally L-shaped radially outwardly extending locking element 92 of the base to be formed after cutting along the cut line.

After the article 70 is cut along the cut-line 74, and separating the base 78 from the container body 76 of the container to be formed, the base is raised relative to the container body and inserted within the lower open end of the container body until the L-shaped lock element 92 of the base snaps into the channel 80. The channel 80 and element 92 serve as interengageable locking formations holding the container body 76 and base 78 closed. The upper edge of the locking element 92 engages the upper wall 82 of the channel 80 which serves as a stop preventing over-insertion of the base. The upper wall 82 of the channel 80 serves as a hinge point to allow the lower portion of the container body to be expanded slightly when the base is initially inserted. The assembled container body 76 and base 78 form a container 93, with the base serving as a closure for the container.

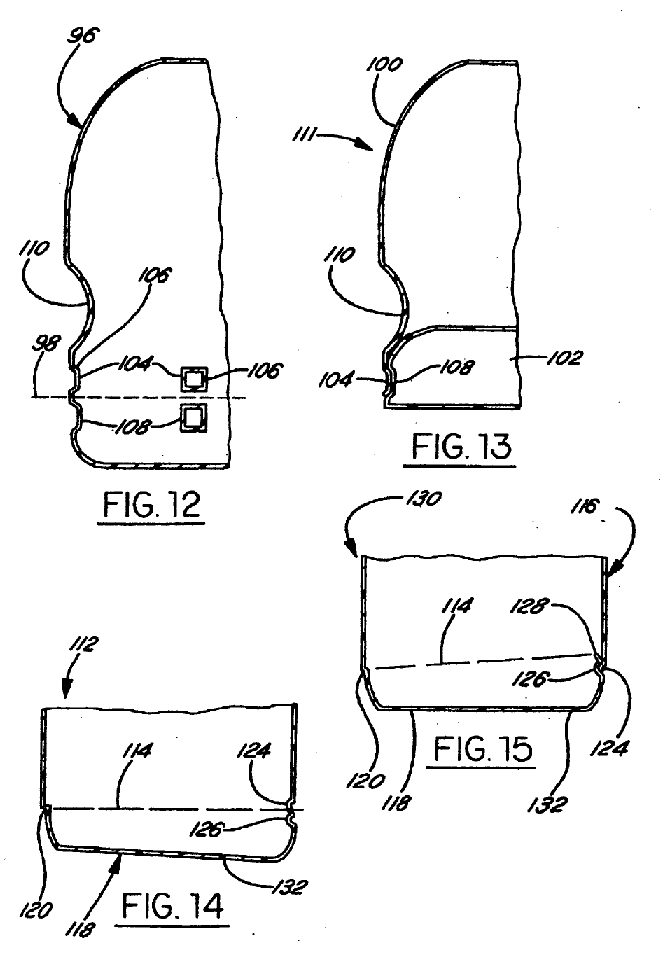

Referring next to FIGS. 12 and 13, there is shown a hollow, plastic, blow-molded article 96 intended to be transversely cut along a cut plane or cut line 98 into two parts, namely a container body 100 and a base 102.

The article 96 above the cut line has two laterally spaced apart molded-in locking formations 104, each of which consists of a radially inward depression bordered by side walls 106 which are inclined radially inwardly at an acute angle toward the bottom of the depression. The article 96 below the cut line likewise has two molded-in locking formations 108 which are complimentary to and of the same configuration as the locking formations 104 and in the same laterally spaced apart relationship as the lock formations 104. A radially inwardly extending and outwardly facing horizontal annular groove 110 extends around the article 96 above the locking formations 104.

After the article 96 is cut along the cut line 98 to separate the base 102 from the container body 100, the base 102 is inverted and inserted through the lower open end of the container body to cause the locking formations 108 of the base to nest with the locking formations 104 of the container body to hold the container body and base closed. The groove 110 serves as an interference stop preventing over-insertion of the base, and also may be used for locating a shrink-wrap labeling around the container. The assembled container body 100 and base 102 form a container 111, with the base serving as a closure for the container.

Referring to FIGS. 14 and 15, there is shown a lower portion of a hollow, plastic, blow-molded article 112 intended to be partially cut, or cut part way, along a cut plane or cut line 114 into two parts, namely a container body 116 and a base 118. After partial cutting, the base 118 is still integrally attached to the container body around a minor portion of the circumference of the article 112 at one side thereof by a connecting portion providing an integral hinge point 120. At the opposite side of the article, at approximately the cut line 114, the article has the configuration shown in FIG. 14 including a radially inwardly extending and outwardly opening channel 124 which crosses and intersects the cut line, and below the cut line a radially inwardly extending and outwardly opening channel 126.

When the article 112 is cut along the partial cut line 114, leaving the base 118 attached to the container body 116 at the hinge point 120, the base can be swung upwardly about the hinge, causing the channel 126 to snap over the inner side of the channel 124 to serve as interengageable locking formations which hold the base closed relative to the body. It will be noted that the lower part of the channel 124 is below the cut line and provides a cam 128 on the base to expand the channel 126 over the channel 124 during the locking of the base to the body. The container body 116 and base 118 when locked together form a container 130, with the base serving as a closure for the container. It should be understood that before locking the base to the container body, the base will be swung downwardly to create an opening of sufficient size to permit a product to be inserted into the container.

The bottom wall 132 of the article 112 is disposed at an acute angle to the longitudinal centerline of the article, so that after partial severance of the article along the cut line and the interengagement of said locking formations the bottom wall 132 is perpendicular to the longitudinal center line.

This disclosure herein is intended to be exemplary, and not limiting. The scope of the invention is defined by the claims appended hereto.

1. A method of making a container for an item of merchandise or the like, comprising:
(a) blow molding a hollow article having a container body connected to an integral base along a cut line,
(b) severing said base from said container body along said cut line, and
(c) telescoping said container body and said base together to form the container.

2. The method set forth in claim 1 further including the step of interengaging complimentary locking formations of said container body and said base following the telescoping of said container body and said base together according to step (c).

3. A method of making a container body and a closure for the container body that can be joined together to provide a container, the method including the steps of:
(a) providing a mold having a cavity with at least a first parting line, said cavity being contoured on one side of said first parting line to form the container body and on an opposing side of said first parting line to form the closure,
(b) blow molding a tubular parison within said cavity to form a hollow blow-molded article,
(c) opening said cavity at said first parting line, and
(d) extending a cutter blade into said cavity at said first parting line to sever the closure from the container body.

4. The method set forth in claim 3 wherein said mold cavity provided in said step (a) has a second parting line orthogonal to said first parting line,
opening said cavity at said second parting line a first distance prior to the opening of said cavity at said first parting line in step (c) to relieve the mold clamp pressure, and
after the severing of the closure from the body in step (d), opening said cavity at said second parting line a further distance while maintaining the cavity open at said first parting line to allow the container body and the closure to be removed from said cavity.

5. A mold for blow molding a hollow article adapted to be severed to form a container body and a closure for the container body, which includes:
a pair of first mold halves and a pair of second mold halves, said first and second mold halves when closed against each other forming a blow mold cavity, said first mold halves being separable from said second mold halves along a first parting line, said first mold halves being separable from each other along a second parting line and said second mold halves being separable from each other along a third parting line, and
a knife carried by one of said mold halves at a position external to said cavity and being extendable along said first parting line through said cavity between said first and second mold halves when said first mold halves are separated from said second mold halves to sever the article to form the container body and the closure.

6. A hollow blow-molded article adapted to be severed along a cut line to form a container for an item of merchandise or the like, which includes:
a container body and a base which together form the hollow blow-molded article, said container body and said base being integrally connected by a wall intersecting and crossing said cut line,
said container body and said base being adapted to be telescopically joined together at an open end of said container body after severance of said article along said cut line.

7. The hollow blow-molded article set forth in claim 6 wherein said container body and said base have interengageable locking formations adapted to retain said container body and said base telescopically jointed together to form said container.

8. The hollow blow-molded article set forth in claim 7 wherein said base is adapted to be telescopically received over the open end of the container body after severance from the container body, said interengageable locking formations comprising:
a radially inwardly extending channel extending around said container body and spaced from said cut plane,
a radially inwardly extending channel extending around said base and spaced from said cut plane,
said channel in said base being received in the channel in the container body when the container body and base are telescopically joined together.

9. The hollow blow-molded article set forth in claim 8 wherein the channel in the base is closely adjacent to the cut line so that the channel in the base will expand the base as the base is received over the open end of the container body.

10. The hollow blow-molded article set forth in claim 9, wherein said container body has a tapered outer surface adjacent to the channel in the container body to be contacted by the channel in the base as the base is received over the open end of the body to expand the channel in the base whereby the channel in the base will resiliently snap into the channel in the container body in a final assembled relationship of the container body and the base.

11. The hollow blow molded article of claim 10, wherein an upper edge of the channel in the container body is adapted to engage an upper edge of the base to positively locate the base in the final assembled relationship of the container body and the base.

12. The hollow blow-molded article set forth in claim 7 wherein said base is adapted to be telescopically received within an open end of said body following severance from said body along the cut line, said interengageable locking formations comprising:
a radially outwardly extending channel extending around said container body and spaced from said cut line, and
a radially outwardly extending locking element extending around said base and disposed within said channel when said base is telescopically received within said body.

13. The hollow blow-molded article set forth in claim 12 wherein said channel is spaced from the cut line, and said channel has a wall connected at a hinge point to a portion of said body on an opposite side of said channel from cut line, said hinge point enabling expansion of said channel and a portion of the connecting wall on said body to facilitate telescopically receiving said base within said body.

14. The hollow blow-molded article set forth in claim 13 wherein said channel has an upper wall engagable by said locking element to serve as a stop preventing over insertion of said base within the open end of the body.

15. The hollow blow-molded article set forth in claim 7 wherein said base is contoured and adapted to be inverted and telescopically inserted into said container body after severance from said container body along the cut line, with said locking formations adapted to engage each other to hold said base within said body.

16. The hollow blow-molded article set forth in claim 15 wherein said interengageable locking formations comprise a depression in said body and a depression in said base.

17. The hollow blow-molded article set forth in claim 7 wherein said body and said base are connected by a connecting wall intersecting said cut line, said connecting wall at one side of the article providing a hinge when the article is severed along said cut line at all points along said cut line except at said hinge enabling said base to be swung away from said body after the severance along said cut line for permit a product to be inserted into the container, and then to be swung toward said body to interengage said locking formations.

18. The hollow blow-molded article set forth in claim 17 wherein said article has a bottom wall disposed at an acute angle to a longitudinal centerline of the article, such that after the severance of the article along the cut line and the interengagement of said locking formations, the bottom wall is perpendicular to the longitudinal center line.

19. A blow-molded article adapted to be severed along a cut line to form a package, which includes:
a hollow body and an integrally blow-molded base forming a hollow closed blow-molded article,
said body and said base being connected by a connecting wall perpendicular to and intersecting the cut line,
said body having at least one lock feature extending radially into said body on one side of said connecting wall,
said base having at least one lock feature extending radially into said base on an opposing side of said connecting wall,
said base being contoured to be inverted and inserted into said body after severance from said body along the cut line, with said lock features engaging each other to hold said base within said body.

20. A blow-molded article adapted to be severed along a cut line to form a package, which includes:
a hollow body and an integrally blow-molded base forming a hollow closed blow-molded article,
said body and said base being connected by a connecting wall having an outer surface intersecting and perpendicular to said cut line,
said body having a radially inwardly extending channel extending around said body parallel to and spaced from the cut line,
said base having a radially inwardly extending channel parallel to the cut line, said base being contoured to be telescopically received over said body after severance from said body with said channel in said base being received within said channel in said body to retain said base on said body.

21. A blow-molded article adapted to be severed along a cut line to form a package, which includes:
a hollow body and an integrally blow-molded base forming a hollow closed blow-molded article,
said body and said base being connected by a connecting wall perpendicular to and intersecting the cut line,
said body having a channel extending radially outwardly from said connecting wall parallel to the cut line,
said base having a portion disposed radially inwardly from said connecting wall, said base being contoured to be telescopically received within said body
following severance from said body along the cut line, such that a portion of said connecting wall on said base is disposed within said channel on said body.
